(19) United States
(12) Patent Application Publication
(10) Pub. No.: US 2017/0208965 A1
(43) Pub. Date: Jul. 27, 2017

(54) APPARATUS FOR ROCKING AN INFANT CAR SEAT

(71) Applicants: Ellen Nasrallah, Jacksonville, FL (US); Joseph H. Nasrallah, Jacksonville, FL (US)

(72) Inventors: Ellen Nasrallah, Jacksonville, FL (US); Joseph H. Nasrallah, Jacksonville, FL (US)

(21) Appl. No.: 15/006,726

(22) Filed: Jan. 26, 2016

(51) Int. Cl. A47D 13/10; B60N 2/26; A47D 1/08; A47D 15/00

(52) U.S. Cl. CPC A47D 13/10; A47D 15/00; B60N 2/26; A47D 1/08

(57) ABSTRACT

An apparatus includes a base unit configured for sitting on a flat surface. A lower neck member is joined to the base unit. An upper neck member is configured to be at least partially received into the lower neck member and further is configured for and up and down motion relative to the lower neck member. A head member is joined proximate to a distal end of the upper neck member. The head member is configured for joining to a surface of a rockable object, wherein the up and down motion is operable for rocking the rockable object. A motor device is disposed within the base unit and is configured for imparting the up and down motion.

### CROSS-REFERENCE TO RELATED APPLICATIONS

Not applicable.

### RELATED CO-PENDING U.S. PATENT APPLICATIONS

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to childcare items. More particularly, the invention relates to an infant car seat carrier-rocking device.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Some caregivers, such as, without limitation, parents or relatives, may experience instances in which they wish to soothe an irritated, fussy, or crying infant or in which they wish to avoid waking a sleeping infant. In some of these cases in which the caregiver may be travelling with the infant, for example without limitation going to a restaurant or doctor's office or visiting friends or family, the infant may be left in their infant car seat removed from the vehicle to keep the infant comfortable. Typically, many infant car seats have two pieces, a base unit that is strapped to a seat belt of a vehicle and a carrier portion that is removable from the base unit. The term carrier may be used interchangeably with the term infant car seat. It is believed that the undersides of many infant car seats and carriers may be rounded, which may enable the seat or carrier to be rocked when placed on a flat surface. This rocking motion may soothe the infant or help prevent the infant from waking. Often, the caregiver may manually rock the seat or carrier using their hand by bending over to reach the seat or carrier or may manually push the seat or carrier up and down with their foot. Due to its manual nature, one may expect that such rocking may be tiresome or even painful for the caregiver, particularly if bending over. In addition, it may be difficult for the caregiver to produce a fluid steady motion.

By way of educational background, an aspect of the prior art generally useful to be aware of is that there are some automated means for rocking infant car seats and carriers currently available. One such approach comprises a wedge-shaped housing and a reciprocating drive mechanism that may be attached to an infant carrier or car seat. Another current approach provides a rocking infant carrier in which the rocking device is built into the carrier. Yet another approach discloses an automobile infant seat rocker device that may be attached to an infant carrier. Yet another current approach discloses a motion apparatus for use in combination with a standard infant carrier, such as a car seat, that cradles and rocks the entire carrier. It is believed that this approach may be large and difficult to transport.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic front view of an exemplary rocking device, in accordance with an embodiment of the present invention;

FIG. 2 is a block diagram of an exemplary rocking device, in accordance with an embodiment of the present invention;

FIG. 3 is a diagrammatic side view of an exemplary rocking device, in accordance with an embodiment of the present invention;

FIG. 4 is a diagrammatic side view of an exemplary rocking device in engagement with an infant car seat, in accordance with an embodiment of the present invention;

FIG. 5 is a diagrammatic side view of an exemplary rocking device and an infant car seat, in accordance with an embodiment of the present invention; and

FIG. 6 is a diagrammatic view of an exemplary rocking device and an infant rocker seat, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). The ordinary meaning of “substantially halfway” is thus reasonably close to or nearly at the midpoint between the forwardmost point of the upper or outsole and the rearwardmost point of the upper or outsole.

Similarly, the term “substantially” is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform’. The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter. Moreover, for any claim of the present invention which claims an embodiment “consisting essentially of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In the description herein, the term carrier may be used interchangeably with the term infant car seat.

Some embodiments of the present invention may provide an infant car seat rocking device that may enable caregivers to soothe a fussy or crying infant. Such embodiments may also be used on various different types of infant carriers including, without limitation, stroller seats and standalone carriers. In some of these embodiments, the rocking device may be a portable device that can rock the carrier, so that the caregiver does not need to do this manually. It is believed that this rocking may help to soothe the infant.

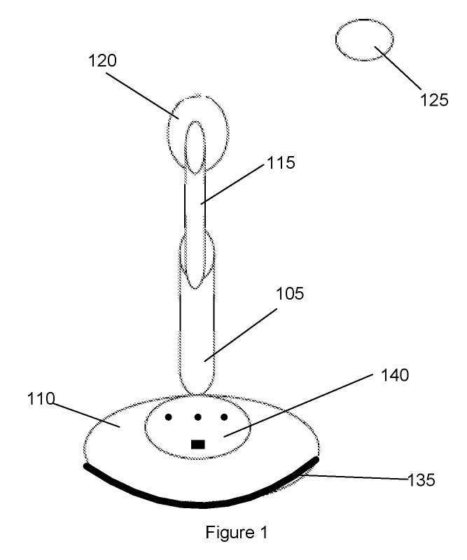

FIG. 1 is a diagrammatic front view of an exemplary rocking device, in accordance with an embodiment of the present invention. In the present embodiment, the rocking device comprises a lower neck 105 attached to a base 110. An upper neck 115 may extend from lower neck 105 in an up and down motion when activated. For example, without limitation, in some embodiments the upper neck may extend upwardly approximately 2 inches then may partially recede into the lower neck 105 when moving in a downward motion giving the device a height of approximately 4 inches when fully extended. It is contemplated that some embodiments may be implemented in which the height of the device and/or the distance that the upper neck extends from the lower neck may be larger or smaller depending on various factors such as, but not limited to, the overall size of the device, the type of carrier being rocked, the size of the infant, where the head is placed on the carrier to be rocked, etc. In the present embodiment, lower neck 105 and upper neck 115 may be substantially cylindrical in shape. It is contemplated that the necks in some alternate embodiments may be shaped differently. For example, without limitation, in some embodiments the lower and upper neck may be square or triangular in cross section. In some other embodiments, the lower neck may comprise a different shape from the upper neck. For example, without limitation, the lower neck may have a conical shape to flow into the base, and the upper neck may have a cylindrical shape.

In the present embodiment, a head 120 may be located at the uppermost part of upper neck 115 and may be configured to interact with an attaching mechanism 125 that may be placed on the carrier to be rocked. It is contemplated that attaching mechanism 125 may comprise a multiplicity of suitable attachment means such as, but not limited to, hook and loop material, magnets, magnetic metals, snaps, clasps, buckles, double-sided tape, gummy material, etc. Furthermore, attaching mechanism 125 may be connected to the carrier using various different approaches including, without limitation, being adhered to the underside of the carrier, attaching to the carrier with a strap, being built into the carrier, being screwed or bolted onto the carrier, glued, taped, magnetic force, etc. In the present embodiment, head 120 may be curved or rounded, which may enable head 120 to make connection with attaching mechanism 125 from several areas on head 120 to help maintain connection between head 120 and attaching mechanism 125 throughout the motion of the device and the carrier. Some embodiments may be implemented in which the head at the top portion of the neck may have a variety of shapes. For example, without limitation, some heads may have a flat shape, a round shape, or a pointed shape. In other embodiments the heads may be made of a deformable material such as, but not limited to silicone or rubber, which may enable the head to conform to the shape of the attachment means to help maintain a connection. Those skilled in the art will readily recognize, in light of and in accordance with the teachings of the present invention, that a multiplicity of suitable configurations may be used to create contact between the rocking device and the carrier. For example, without limitation, in some embodiments the device may comprise means for attaching directly to carrier without an attaching mechanism. In some such embodiments, one or more suctions cups or vacuum cups may be placed on the end of the upper neck to create a connection with the carrier. Other such embodiments may comprise elastic or adjustable belts that may be wrapped around a portion of the carrier. Yet other such embodiments may comprise clips or clamps that may be secured onto a portion of the carrier. Yet other such embodiments may comprise a support structure that may cradle a portion of the carrier. In some alternate embodiments, the rocking device may make contact with the carrier without connecting to the carrier so that the device may push the carrier upward and then allow gravity to cause the carrier to rock back down for the next stroke of the device to push the carrier up again.

In the present embodiment, base 110 may function to stabilize the device in an upright position and may comprise user controls 140 such as, but not limited to, an on/off switch or button. Base 110 may be round in shape with a diameter of approximately 4 inches. It is contemplated that some embodiments may have bases of various different shapes and sizes. In many embodiments, it may be desired to have a weight of base 110 to be sufficient to prevent tipping during use. In some alternate embodiment, a weight may be added internally to base 110. In some embodiments, a bottom of base 110 may have an attached material 135 such as, but not limited to, rubber, foam, etc. to prevent slippage during use. In an alternate embodiment, base 110 may include a suction device to attach to a floor. In an alternate embodiment, the device may be configured without a lower neck so that the upper neck may extend directly from the base, or the device may be configured without an upper or lower neck so that the base itself may extend upwards. In the present embodiment, base 110 may also house a motor for actuating the upward and downward motion of upper neck 115. In alternative embodiments, the motor may impart the upward and downward motion to the rocking device. Those skilled in the art will readily recognize, in light of and in accordance with the teachings of the present invention, that a multiplicity of suitable motor types may be used to create the up and down motion of upper neck 115. For example, without limitation, some embodiments may use reciprocating electric motors, linear motors, or conventional electric motors that comprise means for converting rotational energy into linear energy. In some embodiments hydraulic or pneumatic pistons may be used to actuate the upper neck. In the present embodiment, the device may be battery operated, typically using standard household batteries, which may also be housed within base 110. Some embodiments may also include an A/C adapter that may enable the device to run off of a conventional electric outlet. Some alternate embodiments may be implemented without an electrically powered motor. One such embodiment may comprise a foot pump that may enable the caregiver to pump air into the device to force the upper neck to move in an upward motion then move in a downward motion once the air is released.

It is contemplated that various optional features may be provided in some embodiments, the controls for which may be located on the base of the device. For example, without limitation, some embodiments may be able to play soft music or relaxing sounds to help soothe the infant. Another feature, which may be included to assist the caregiver, is a timer that may be set so that the device runs for a set period of time, such as, but not limited to, 15 or 30 minutes, then shuts down. Yet other optional features that may be incorporated into some embodiments may include, without limitation, light projectors, the release of calming aromas such as but not limited to lavender, carrying straps, etc. In the present embodiment, the device may be made of a lightweight yet durable and child-safe material, for example, without limitation, plastic. This may enable the device to be light, typically under 3 lbs., and easily transportable. Some alternate embodiments may be made of various different materials including, but not limited to, metals, wood, cardboard, composite materials, nylon, rubber, or a combination of materials. It is contemplated that some embodiments may be configured as an add-on to existing infant carrier products while other embodiments may be configured as standalone products. Many embodiments may be inexpensive to manufacture and purchase. In other embodiments, the rocking device may be configured to be collapsed or folded for transport or storage.

In typical use of the preset embodiment, the rocking device may connect to or somehow come into contact with the underside of an infant carrier and may produce an up and down reciprocating motion to gently rock the carrier, which may be helpful in soothing a fussy or crying infant. First, a user may place the infant carrier on a flat and secure surface such as, but not limited to, a floor. The user may then place the device under the carrier, positioning head 120 directly under the matching attaching mechanism 125, which may typically be positioned under, or near, a front portion of the carrier. In some embodiments, the user may attach attaching mechanism 125 to the carrier. In some other embodiments, attaching mechanism 125 may be built in or attached by a manufacturer of the carrier, Then, using the corresponding connection means between head 120 and attaching mechanism 125, for example, without limitation, hook and loop material, magnets, or suction cups, the user connects attaching mechanism 125 to head 120. The user may then activate/turn the device on using power controls 140 that may typically be located on the top-side of base 110. If available, the user may elect to turn on any additional features that may be provided on the device such as, but not limited to, a timer or music, the controls 140 for which may also typically be located on the top side of base 110. In some alternate embodiments some or all of the controls 140 may be located in positions other than the top of the base including, without limitation, the underside of the base, the side of the base, the lower neck, or the upper neck. In the present embodiment, once the actuation means is functioning, upper neck 115 may extend upward from lower neck 105 then move downwardly to recede into lower neck 105. The up and down motion of upper neck 115 may enable head 120 to push and pull the carrier gently and in a fluid manner, thereby typically causing the infant carrier seat to rock softly. It is believed that this rocking motion may help to soothe an irritated, fussy or crying infant, typically causing the infant to fall asleep. In addition, if the infant is already asleep, the rocking motion may help to keep the infant asleep. If a timer is not available or in use, the user may turn off the device when the rocking motion for the carrier is no longer wanted or needed. A rocking device according to the present embodiment may typically be used virtually anywhere where an infant caregiver may wish to soothe an infant who is located in an infant carrier such as, but not limited to, a home, a restaurant, a doctor's office, other public places, outdoors, etc. In addition, some embodiments may be implemented for use on devices other than infant carriers such as, but not limited to, chairs, bouncers, cribs, sit-on or ride-on toys, cradles, bassinet, etc.

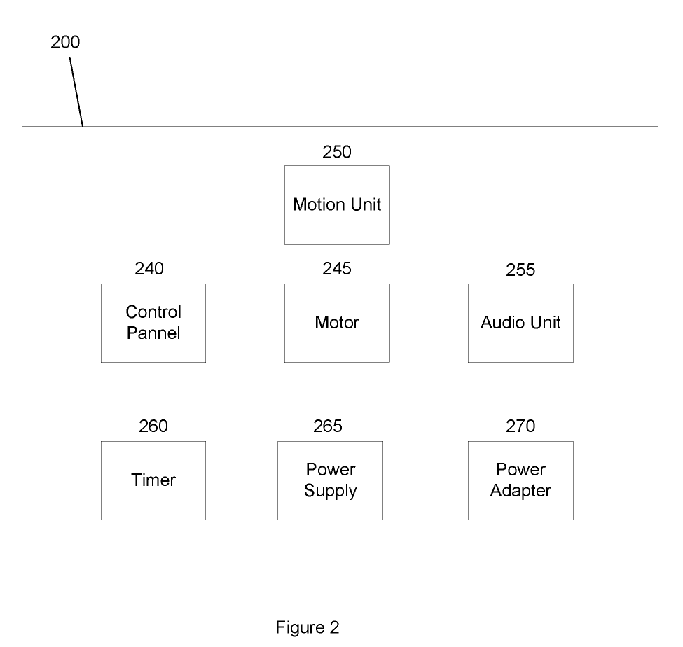

FIG. 2 is a block diagram of an exemplary rocking device, in accordance with an embodiment of the present invention. In the present embodiment, the rocking device 200 comprises a control panel 240, a motor 245, a motion unit 250, an audio unit 255, a timer 260, a power supply 265, and a power adapter 270. Motor 245 may be contained in base 110 and may impart a motion to motion unit 250 Motion unit 250 may operate to impart a rocking motion to an attached infant car seat. Power supply 265 may be contained in base 110 and may provide the necessary power to operate rocking device 200. In the present embodiment, power supply 265 may include one or more batteries. In some embodiments, the batteries may be rechargeable. Power adapter 270 may optionally provide the necessary power to operate rocking device 200 from an external AC outlet. In some embodiments, power adapter may be an external device that plugs into base 110. In some other embodiments, power adapter may be internal to base 110 with a wired or detachable power cord. In some embodiments, power adapter may charge rechargeable batteries in power supply 265. Timer 260 may be operable for activating rocking device 200 for a selected amount of time. In a non-limiting example, the caregiver may select 15 or 30 minutes of rocking time. In another non-limiting example, the caregiver may select any number of minutes within a predetermined range. Audio unit 255 may provide a soothing music to the infant during operation of rocking device 200. As a non-limiting example, audio unit 255 may play one or more lullabies. In some alternate embodiments, may connect wirelessly to the caregiver's portable device for playback of a recorded selection. As a non-limiting example, the caregiver select a favorite musical selection or a voice recording of the caregiver. Control panel 240 may include one or more switches or means for controlling operations of rocking device 200. In some embodiments, the one or more switches may be mounted directly to base 110. In other embodiments, control panel 240 is a separate unit or device mounted to base 110. In some embodiments, control panel 240 may include a master on/off switch. In some other embodiments, control panel 240 may include one or more switches or means for controlling timer 260 and audio unit 255. In other embodiments, control panel 240 may include an input power plug for power adapter 270. In some alternate embodiments, control panel 240 may include indicators such as, but not limited to, low battery indicator, etc. In other alternate embodiments, control panel 240 may include safety features such as, but not limited to, turning off rocking device 200 upon detection of a malfunction such as, but not limited to, malfunctions of motor 245 and/or motion unit 250. In some other alternate embodiments, control panel 240 may include means for controlling a volume level of audio unit 255. In other alternate embodiments, control panel 240 may include means for selecting a speed of a rocking of rocking device 200. In some embodiments, control panel 240 may be located on the top of base 110. In other embodiments, control panel 240 may be located in other locations.

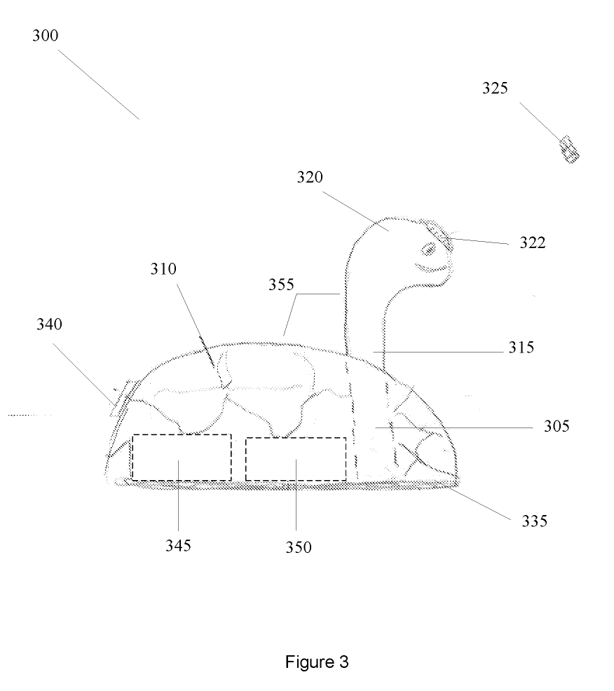

FIG. 3 is a diagrammatic side view of an exemplary rocking device, in accordance with an embodiment of the present invention. In the present embodiment, the rocking device 300 comprises a lower neck 305 attached to a base 310. An upper neck 315 may extend from lower neck 305 in an up and down motion when activated. For example, without limitation, in some embodiments the upper neck may extend upwardly approximately 2 inches then may partially recede into the lower neck 305 when moving in a downward motion

In the present embodiment, a head 320 may be located at the uppermost part of upper neck 315 and may be configured to interact with an attaching mechanism 325 that may be placed on the carrier to be rocked. It is contemplated that attaching mechanism 325 may comprise a multiplicity of suitable attachment means such as, but not limited to, hook and loop material, magnets, magnetic metals, snaps, clasps, buckles, double-sided tape, gummy material, etc. Furthermore, attaching mechanism 325 may be connected to the carrier using various different approaches including, without limitation, being adhered to the underside of the carrier, attaching to the carrier with a strap, being built into the carrier, being screwed or bolted onto the carrier, glued, taped, magnetic force, etc. In the present embodiment, attaching member 322 may be attached to head 320, which may enable head 320 to make connection with attaching mechanism 325. Attaching member may comprise a multiplicity of suitable attachment means such as, but not limited to, hook and loop material, magnets, magnetic metals, snaps, clasps, buckles, double-sided tape, gummy material, etc.

In the present embodiment, base 310 may function to stabilize the device in an upright position and may comprise user controls 340 such as, but not limited to, an on/off switch or button. Interior to base 310 may be a battery compartment 345 and a motor compartment 350. In some embodiments, a bottom of base 310 may have an attached material 335 such as, but not limited to rubber, foam, etc. to prevent slippage during use. In the present embodiment, rocking device 300 may include a covering 355. Covering 355 may comprise, without limitation, a fabric material, plastic, vinyl, etc. to provide an ornamental design to rocking device 300.

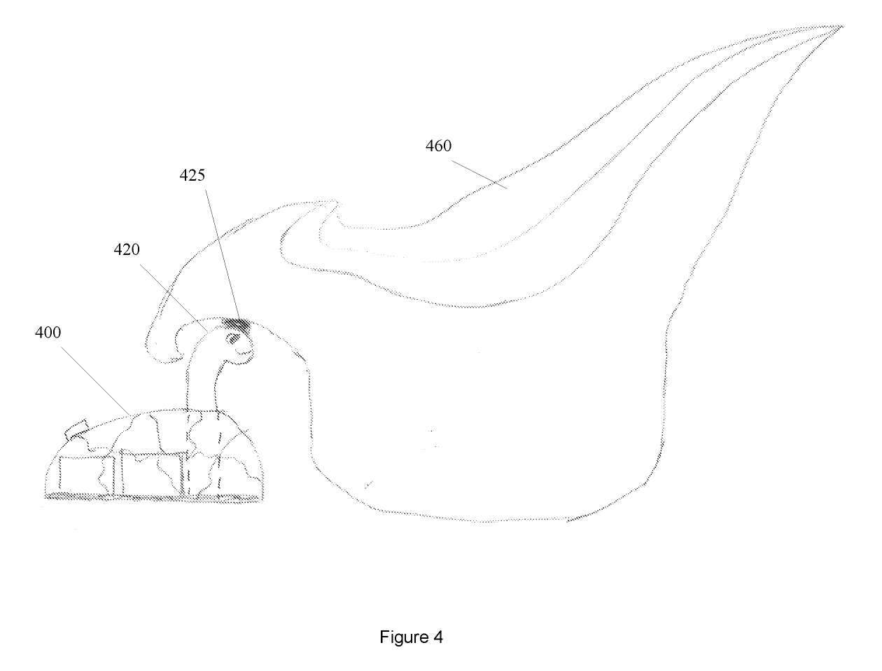

FIG. 4 is a diagrammatic side view of an exemplary rocking device in engagement with an infant car seat, in accordance with an embodiment of the present invention. In the present embodiment, the rocking device 400 may be positioned under a front portion of an infant car seat 460 and attached to the infant car seat with an attaching mechanism 425. In the present embodiment, an up and down movement of a head 420 may impart a rocking motion to infant car seat 460.

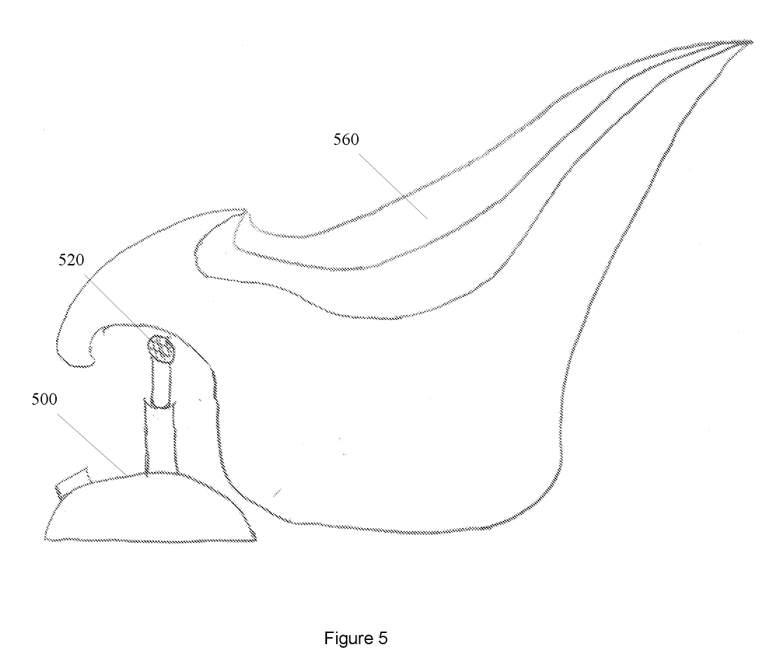

FIG. 5 is a diagrammatic side view of an exemplary rocking device and an infant car seat, in accordance with an embodiment of the present invention. In the present embodiment, the rocking device 500 may be positioned under a front portion of an infant car seat 560 with a head 520 aligned for contacting an underside of infant car seat 560. In the present embodiment, an up and down movement of a head 520 may impart a rocking motion to infant car seat 560.

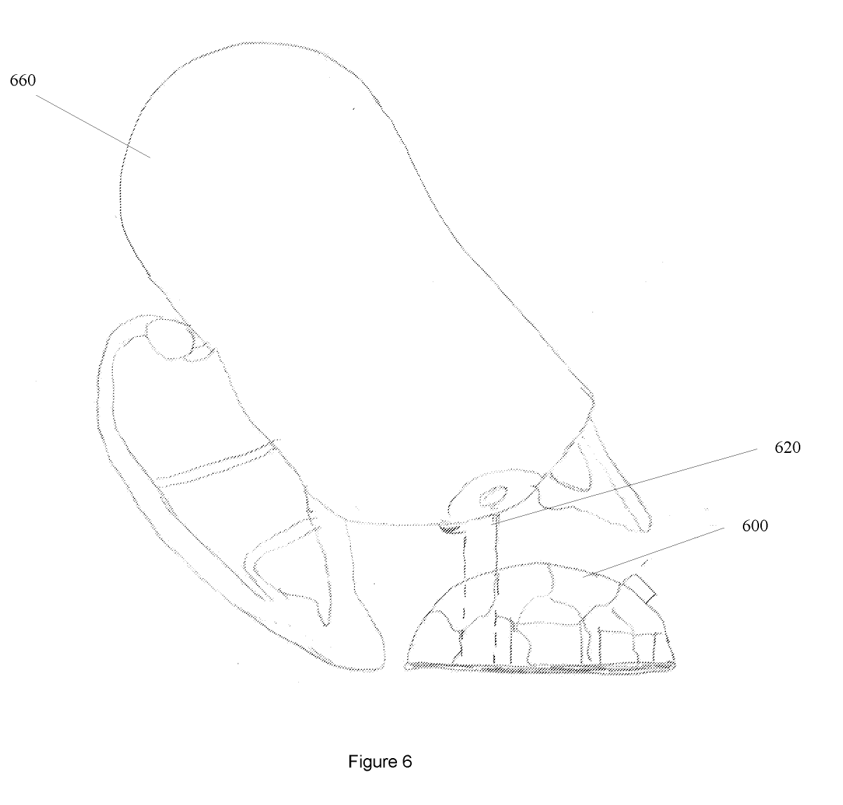

FIG. 6 is a diagrammatic view of an exemplary rocking device and an infant rocker seat, in accordance with an embodiment of the present invention. In the present embodiment, the rocking device 600 may be positioned under a front portion of an infant rocker seat 660 with a head 620 attached to an underside of infant rocker seat 660. In a non-limiting example, head 620 may be attached to a fabric or plastic underside of infant rocker seat 660. In the present embodiment, an up and down movement of a head 620 may impart a rocking motion to infant rocker seat 660.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing an infant carrier rocking device according to the present invention will be apparent to those skilled in the art. Various aspects of the invention have been described above by way of illustration, and the specific embodiments disclosed are not intended to limit the invention to the particular forms disclosed. The particular implementation of the infant carrier rocking device may vary depending upon the particular context or application. By way of example, and not limitation, the rocking devices described in the foregoing were principally directed to vertically actuating implementations; however, similar techniques may instead be applied to devices that may translate a rotating or pivoting motion into a rocking motion, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus for rocking a rockable object comprising:
a base unit being configured for sitting on a flat surface;
a lower neck member being joined to said base unit;
an upper neck being configured to be at least received into said lower neck member and further being configured for up and down motion relative to said lower neck member;
a head member being joined proximate to a distal end of said upper neck member, said head member being configured for engaging with an underside surface of the rockable object, said head member further comprising an attaching mechanism being configured for removably attaching said head member to the rockable object, the attachment mechanism comprising a first male attachment means configured for attachment to the rockable object and a second complementary male attachment means attached to the head member for releasable attachment to the first attachment means of rockable object, the rockable object free of contact with said base unit, wherein said head member and attaching mechanism pushes and pulls the rockable object upwardly and downwardly, respectively, during said up and down motion of said lower neck member and rocking the rockable object; and
a motor device being disposed within said base unit and being configured for imparting said up and down motion of the upper neck member.

2. The apparatus as recited in claim 1, further comprising said attaching mechanism being configured for removably attaching said head member to the rockable object and an attaching member upon said head member connecting to said attaching mechanism, being said complementary male attachment means.

3-10. (canceled)

11. The apparatus as recited in claim 1, in which the rockable object is an infant car seat.

12. An apparatus for rocking a rockable object comprising:
means for sitting on a flat surface, said means for sitting being a base unit;
means for extending upward from said sitting means;
means for up and down motion relative to said extending means;
means for engaging with a surface of a rockable object, further comprising said attaching mechanism being configured for removably attaching said head member to said surface of the rockable object, the attachment mechanism comprising a first male attachment means configured for attachment to the rockable object and a second complementary male attachment means attached to the head member for releasable attachment to the first attachment means of the rockable object, wherein said head member and attaching mechanism pushes and pulls the rockable object upwardly and downwardly, respectively, during said up and down motion of said lower neck member for rocking the rockable object; and
means for imparting said up and down motion.

13. The apparatus as recited in claim 12, further comprising means for removably joining said joining means to the rockable object, said joining means comprising said attaching member upon a head member and said attaching mechanism on the rockable object.

14. (canceled)

15. (canceled)

16. The apparatus as recited in claim 12, further comprising means for activating said imparting means during a selected period of time.

17. The apparatus as recited in claim 12, further comprising means for reproducing an audio recording.

18. The apparatus as recited in claim 12, further comprising means for supplying power to a motor device being said means for imparting said up and down motion.

19. The apparatus for rocking a rockable object comprising:
a base unit being configured for sitting on a floor;
a lower neck member being joined to said base unit to extend in a generally upward direction from said base unit;
an upper neck being configured to be at least partially received into said lower neck member and further being configured for up and down motion relative to said lower neck member;
a head member being joined proximate to a distal end of said upper neck member, said head member being configured for removably attaching to a surface of an infant car seat, further comprising an attaching mechanism being configured for removably attaching said head member to the infant car seat, the attachment mechanism comprising a first male attachment means configured for attachment to the rockable object and a second complementary male attachment means attached to the head member for releasable attachment to the first attachment means of the rockable object, the infant car seat free of contact with said base unit, wherein said head member and said attaching mechanism pushes and pulls the rockable object upwardly and downwardly, respectively, during said up and down motion of said lower neck member and rocking moves the infant car seat in a rocking manner; and
a motor device being disposed within said base unit and being configured for imparting said up and down motion of the upper neck member.

20. The apparatus as recited in claim 19, further comprising: a material being joined to a bottom of said base unit for mitigating slippage on the flat surface during operation of the apparatus; a timer unit being configured for activating said motor during a period of time selected by a user; an audio unit being configured for reproducing an audio recording selected by the user; a control unit being disposed on a top of said base unit and being configured for activating and deactivating said motor device, controlling said timer unit, and controlling said audio unit; a power supply comprising batteries and being configured for at least supplying power to said control panel for operating said motor device, said timer unit and said audio unit; and a power adapter being configured for at least supplying power to said control panel.

21. The apparatus as defined in claim 2, wherein said attaching mechanism and said attaching member comprise hook and loop materials, magnets, magnetic materials, suction cups, snaps, clasps, buckles, double-sided tape, and gummy materials.

22. The apparatus as defined in claim 13, wherein said attaching mechanism and said attaching member comprise hook and loop materials, magnets, magnetic materials, suction cups, snaps, clasps, buckles, double-sided tape, and gummy materials.

23. The apparatus as defined in claim 19, wherein said attaching mechanism upon said infant car seat and said attaching member upon said head member comprise hook and loop materials, magnets, magnetic materials, suction cups, snaps, clasps, buckles, double-sided tape and gummy materials.
